(19) United States
(12) Patent Application Publication
(10) Pub. No.: US 2010/0046483 A1
(43) Pub. Date: Feb. 25, 2010

(54) PROTOCOL FOR SWITCHING BETWEEN CHANNELS IN TYPE 2 AGILE RADIO

(75) Inventor: Sai Shankar Nandagopalan, San Diego, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 11/993,619

(22) PCT Filed: Jun. 27, 2006
(86) PCT No.: PCT/IB2006/052135

§ 371 Date: Dec. 21, 2007

Related U.S. Application Data
(60) Provisional application No. 60/695,089, filed on Jun. 29, 2005.

(51) Int. Cl. H04B 7/212; H04B 17/00; H04L 27/28

(52) U.S. Cl. 370/337; 455/67.11; 375/260

(57) ABSTRACT

The system (400), apparatus (401.j), and method (100) of the present invention provide a way to expand and contract the available wireless channels opportunistically by optimally switching the OFDM carriers. The present invention employs a spectrum occupancy information element (200) and a local spectrum occupancy database (505) respectively for exchange of spectrum occupancy information with other devices and persistent storage of spectrum occupancy information, both of which enable seamless working of agile radios in such a way that their transmission capacity is greatly enhanced.

This invention provides a system, apparatus and method to expand and contract the available wireless channels opportunistically by optimally switching the orthogonal frequency division multiplexing (OFDM) carriers.

An agile radio is an agile device whose channel modulation waveforms are defined in software. That is, waveforms are generated as sampled digital signals, converted from digital to analog via a wideband Analog to Digital Converter (DAC) and then possibly upconverted from IF to RF. The receiver, similarly, employs a wideband Analog to Digital Converter (ADC) that captures all of the channels of the software radio node. The receiver then extracts, downconverts and demodulates the channel waveform using software on a general purpose processor.

Thus, an agile radio provides the ability to select any supported radio protocol or associated frequency band using a single radio implementation. An agile radio system can scan for vacant spectrum and then opportunistically grab and use it to send packets of data or voice. With agile transmitters or spread spectrum techniques, many different transmitters can operate in the same wide frequency band with no hard ‘blocking’ limit. Agile radios operate by intrusion into spectrum of other users during periods of non-usage and when these systems overload, the voice-quality deteriorates and errors creep into the data traffic. They are said to “degrade gracefully”.

Currently there is no way for a device to determine spectrum occupancy except by scanning the spectrum for actual use, determining the type of use and keeping a record of each of the determined types of use. A more efficient and consistent way of determining spectrum occupancy and occupancy types is therefore needed.

The system, apparatus, and method of the present invention provides a way for an agile radio of type 2 to expand and contract the available wireless channels opportunistically by optimally switching the orthogonal frequency division modulation (OFDM) carriers. The protocol of the present invention is the first of its kind and enables seamless working of agile radios in such a way that the available wireless channel capacity is greatly enhanced.

The system, apparatus, and method of the present invention employs a spectrum occupancy information element (SOIE) 200 that is the transmitted by all agile devices to indicate spectrum occupancy information and which is scanned, i.e., received, when the agile device is not transmitting. A local database of scanned information is maintained by each agile device concerning spectrum occupancy. When occupancy by a primary is detected the agile radio switches-off the channels occupied by the primary. A primary is a licensed radio system operating in licensed bands. When occupancy by a secondary or other agile device is detected the agile device may or may not vacate the channel depending on the availability of other channels to the agile device, i.e., on whether or not there is sufficient alternative channel availability.

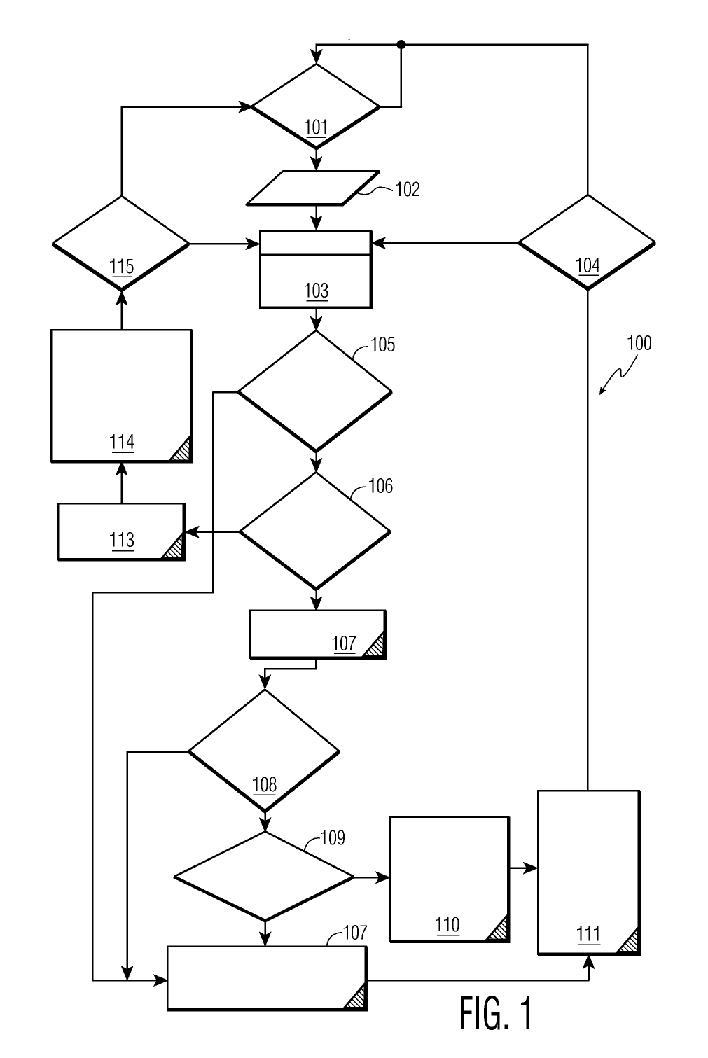

FIG. 1 is a high level flow diagram of the switching of carriers based on primary detection;

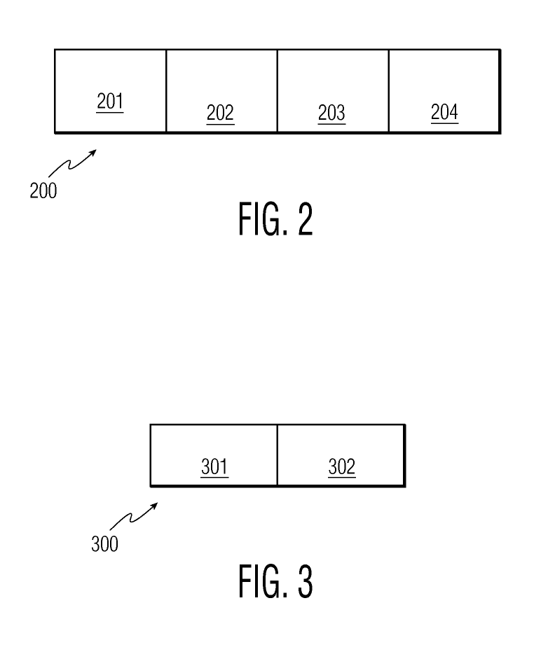

FIG. 2 illustrates the format of a Spectrum Occupancy Information Element; and

FIG. 3 illustrates the format of the Range of Spectrum field of the Spectrum Occupancy Information Element of FIG. 2.

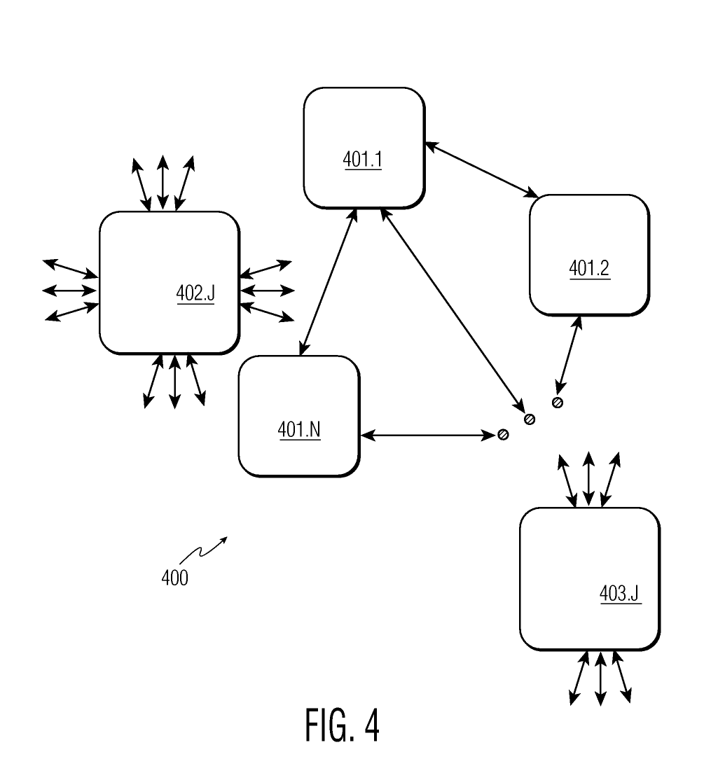

FIG. 4 illustrates agile devices sharing spectrum with primary and secondary devices.

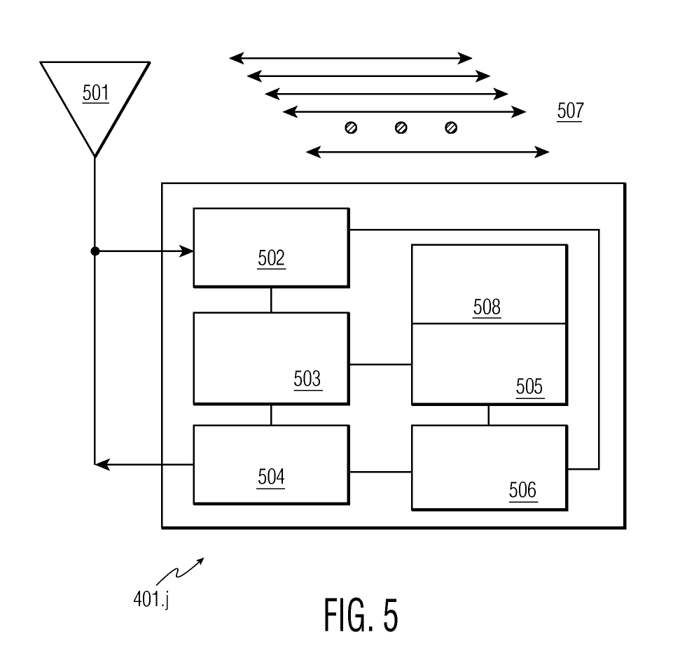

FIG. 5. illustrates an agile radio modified according to the present invention.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

In a preferred embodiment of a generalized approach that is illustrated in FIGS. 4 and 5, a spectral agile radio of type 2 401.j scans the frequency spectrum 507 and maintains a database 505 of spectrum occupancy measurement using an included information element processing module 506. Based on this database 505 that the agile device maintains locally as a result of scanning, the agile device 401.j can decide to switch-ON carriers in the parts of the spectrum that are not used by a primary 402.j or other secondaries 403.j. This switching decision, in a preferred embodiment, is accomplished by a carrier switching module 503 included in the agile device, the module 503 analyzing the spectrum occupancy database 505.

In a preferred embodiment, the system, apparatus, and method of the present invention work as follows. First, the agile device 401.j divides the frequency spectrum into N small channels 507. Then, the agile device 401.j monitors each of the N channels simultaneously received by an included receiver 502 and scanning each of the received N channels 507 for a specified length of time, say T. Then, using an included carrier switching module 502, the agile device 401.j updates a spectrum occupancy database 505 with measurements of the occupancies of these received N channels 507. If the agile device 401.j discovers that some parts of the N channels 507 are not used, it switches ON the carriers in those parts of the N channels 507 and switches OFF carriers in those of the N channels 507 that are occupied by the measured primaries 402.j or secondaries 403.j.

The agile device 401.j listens to all the N channels 507 at all times when the agile device 401.j has no data to transmit. The agile device 401.j updates its local database 505 and makes decisions to switch ON particular carriers or not switch ON particular carriers based on the measurement results and database 505 updates. If the agile device 401.j discovers that one of the channels where its carrier is switched ON has some new occupancy, the agile device 401.j detects whether it is a primary 402.j or secondary 403.j occupancy. If it is a primary 402.j occupancy, the agile device 401.j immediately leaves the channel by switching OFF the corresponding carriers.

The primary 402.j occupancies are detected based on the fact that the signature of the waveforms of the primaries is already known, e.g., stored in an included database 508, and is detectable by the agile device 401.j. As an example, if the detected occupancy is in the TV band, the agile device knows the signature of the synchronization pulse of both analog and digital TVs.

If it is a secondary 403.j occupancy, the agile device 401.j may or may not decide to vacate the channel. The agile device 401.j may decide to vacate the channel if it can find enough opportunities in the other parts of the spectrum. However, if the agile device 401.j finds that there is not enough spectrum availability then the agile radio may decide to coexist with the other secondary 403.j.

Assume the agile device 401.j has divided the spectrum into N small channels 507 where “i”=1, . . . , N. Referring to FIG. 1, when it is determined to be time to scan channels at step 101, a counter “” is set equal to zero at step 102.

At step 103 the counter “i” is incremented by one and channel “i” is scanned and measurements taken.

If it is determined that channel “i” is not occupied at step 105, step 112 is performed.

If it is determined that channel “i” is occupied at step 105, it is further determined at step 106 if the occupied channel is occupied by a primary 4024.j. If channel “i” is occupied by a primary 402.j the database 505 is updated at step 113 and the agile device 401.j quits channel “i” temporarily by switching OFF the carriers at step 114. If channel “i” is the last channel at step 115, step 101 is executed. Otherwise, step 103 is executed to continue the scan of the spectrum.

If it is determined at step 106 that the channel is occupied by a primary 402.j then at step 113 the database 505 is updated with the measurements and the agile device 4014.j quits channel “i” by switching OFF the carriers. If it is determined that this is the last channel at step 115 then step 101 is performed. Otherwise, step 103 is performed.

If it is determined at step 106 that the channel is not occupied by a primary 402.j then at step 107 the database 505 is updated and it is further determined at step 108 whether or not channel “i” is occupied by a secondary and, if not, then step 112 is performed. If at step 108 it is determined that channel “i” is occupied by a secondary 403.j, then at step 109 it is determined if there are enough spectrum resources. If there are enough spectrum resources, the agile device does not opportunistically grab this channel but at step 110 leaves this resource and goes on to other spectrum opportunities by performing step 111. Otherwise, step 112 is performed.

At step 111 the database 505 is updated to record whether or not the spectrum opportunity is occupied. Then at step 104, if this is the last channel step 103 is performed. Otherwise, step 101 is performed.

At step 112 the agile devices switches ON corresponding carriers to occupy the current spectrum opportunity of channel “i”.

However, the algorithm of FIG. 1 alone is not sufficient, as FCC rules mandate that a channel be vacated immediately by the agile device once a primary 402.i is detected. When the agile device is listening or receiving, vacating the channel is straightforward. However, it is difficult for the agile device to vacate a channel when it is transmitting.

When the agile device is transmitting in the whole or partial frequency band based on the spectrum availability, the agile device always expects the receiver MAC to acknowledge. If the source MAC has waited for a duration of ACKTimeout, the agile device may decide that there is a collision with the primary 402.j and may immediately vacate the channel as there is no other way to determine if the ACKTimeout was a result of a collision with a secondary 403.j or because of the primary 402.j arriving at that time instant and resuming its transmission.

This issue is addressed in the system, apparatus, and method of the present invention by taking into account the following possibilities:

1. Assume that the primary's 402.j occupancy in its channel is greater than the transmission time for one frame from the secondary 403.j. Consider the case that the preamble header was received correctly with the receiver MAC getting the preamble correcting sequence (PCS) cleared but not the FCS cleared, then the receiver MAC may assume it is a collision with another device of the same type and protocol and indicate to the sender a NACK frame that will be used by the sender to confirm that the frame was lost because of channel conditions, such as, fading or collision with another secondary device 403.j that is of the same type as the receiver MAC.

2. Consider another case where the sender does not receive the NACK because of a PCS failure or there is an ACK time out. Then the sender immediately vacates the current channel. Other passive listening devices quit this channel as they verify the signature of the primary 402.j and quit the current channel by switching OFF the corresponding carriers. If there was no primary transmission, then the other devices do not switch OFF their carriers. The sender, in this case of ACK timeout, waits for an extra time, called the “sensing time”, to see if there is any activity from the primary 4024.j. If it detects no primary signature then it recognizes that it is because of either channel fading or collisions and may not switch OFF the carriers in the channel.

An underlay approach is required. In the underlay approach, the agile device transmits its information below noise floors so that there is no interference with the existing primary 402.j and secondary 403.j networks. Let the entire frequency space that this agile device is operating in be given as f. Then f/f₀ represents the number of channels that are present in the spectrum in which the agile device is operating. Given current technologies, the value of f is 7 GHz (assuming the agile radio operates from 3 GHz to 10 GHz). f₀ can be of the order of 20 MHz, as an example. Then, the total number of channels in the given band of 7 GHz is

$$N = \frac{f}{{f}_{0}} = \frac{7 \times {10}^{9}}{20 \times {10}^{6}} = 3500$$

A preferred embodiment of the system and met hod of the present invention for each of several existing standards is as follows:

1. MBOA UWB MAC: Assume that the current MBOA PUY implements the protocol outlined in FIG. 1. There are two alternative preferred embodiments with which the spectrum is accessible. In the first preferred embodiment, the sender indicates the spectrum bandwidths that are available in its beacon and monitors the destinations for similar information when they send their beacons, e.g., SOIEs processed by an information element processing module 506. One can signal those available channels in the same way as the DRP information element is indicated in the current MBOA MAC DEV group with the starting frequency offset and the duration of the available channels. The intersections of both sets of spectrum information are used by the sender to communicate to a particular destination. Since the beacon frames are sent using the underlay approach, all agile devices use the entire channel and exchange the hidden node information. The beacon period is fixed and appears every super frame as defined in the MBOA MAC protocol. This solution is particular for MBOA UWB and not suitable if the MAC is based only on CSMA/CA as in 802.11. The spectrum occupancy information element 200 is illustrated in FIG. 2.

The periodicity field 201 indicates if the spectrum occupancies are periodic or not. If the periodicity bit is set to 1, the Range of Spectrum field 202 determines the range of spectrum to which the periodicity field 201 applies. Then, the Frequency Offset 203 and the Number of Carriers 204 repeats. The Range of Spectrum field 202 is further elaborated and shown in FIG. 3.

2. IEEE 802.11 and its extensions: In a preferred embodiment for IEEE 802.11 and its extensions, the RTS message is elongated with the addition of spectrum occupancy information elements (SOIEs) 200 and they indicate the nature of their spectrum opportunities to the receiver using an underlay approach. The receiver responds in the underlay approach with the possible spectrum frequencies and both of them perform an AND operation on each other's spectrum availabilities so that the transmitter uses these common spectrum opportunities to transmit the frame and the receiver uses these common spectrum opportunities to receive the transmitted data frame after RTS and CTS. The SOIE 200 is appended in the RTS to indicate the current occupancy by a particular device using an overlay approach and the receiver responds with a similar field in its CTS message.

3. TDMA protocols inclusive of Bluetooth IEEE 802.15.3 and other TDD protocols like IEEE 802.16: In a preferred embodiment for these protocols, one of the slots is dedicated as a broadcast slot in the super frame after the transmission of the beacon frame. Since these are centralized protocols, the base station or central controller collects information for all the channel measurements from all the receivers in the last super frame and does the AND operation based on its own measurements and indicates to the stations the spectrum opportunities that can be used in the current super frame.

4. FDMA protocols: In a preferred embodiment for FDMA protocols, one of the channels having a lower bandwidth is used exclusively by all stations in TDMA fashion or in contention-based fashion wherein the sender captures that channel and uses an SOIE 200 to transmit the spectrum opportunities it is going to use to transmit the frame to a particular receiver. The receiver responds to its spectrum opportunities as an ACK frame in the control channel and as before the AND operation of the available spectrum opportunities is done to decide the spectrum opportunities to transmit the frame.

While the preferred embodiments of the present invention have been illustrated and described, it will be understood by those skilled in the art, the protocol applications as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling with the scope of the appended claims.

1. A method for switching by an agile device (401.j) between channels of the radio frequency spectrum, comprising the steps of:
scanning the medium to create measurements of occupancy of the radio frequency spectrum;
recording scanned measurements of occupied parts of the radio frequency spectrum in a database (505);
determining spectrum bandwidths that are available from the recorded measurements in the database;
transmitting, with an underlay approach, the determined spectrum bandwidths that are available as spectrum occupancy information;
receiving spectrum occupancy information from other agile devices;
ANDing the transmitted and received spectrum occupancy information to obtain the parts of the radio spectrum that are not being used;
switching OFF transmission by the agile device in the recorded occupied parts; and
switching ON transmission by the agile device in the parts of the radio spectrum that are not being used as obtained as a result of the ANDing step.

2. The method of claim 1, wherein the scanning step is performed whenever the agile device has no data to transmit.

3. The method of claim 1, further comprising the step of determining scanned measurements are of occupied parts with at least one predetermined definition of a primary and of a secondary.

4. The method of claim 3, wherein a primary is a primary is a licensed radio system operating in at least one licensed band and a secondary is an unlicensed radio system operating in ISM or U-NII bands.

5. The method of claim 3, wherein the switching OFF step further comprises the step of immediately switching OFF corresponding carriers whenever a new occupancy by a primary is detected.

6. The method of claim 1, further comprising the steps of:
prior to the scanning step, dividing the radio frequency spectrum into a pre-determined number N of small channels; and
performing the scanning and recording steps with respect to each of the N small channels (507) such that the database is updated with scanned measurements of the occupancies of each of the N small channels.

7. The method of claim 6, further comprising the step of determining scanned measurements are of occupied parts using at least one pre-determined definition of a primary and of a secondary.

8. The method of claim 7, wherein the scanning step is performed whenever the agile device (401.j) has no data to transmit.

9. The method of claim 8, wherein the switching OFF step further comprises the step of immediately switching OFF corresponding carriers whenever a new occupancy by a primary is detected.

10. The method of claim 9, further comprising the steps of:
when the agile device is transmitting, waiting a predetermined amount of time for an acknowledgement sent by a receiver;
if the agile device receives a NACK frame from a receiver, the agile device (401.j) performs the recording step to record occupancy by a secondary device; and
if the agile device does not receive a NACK frame from a receiver, the agile device performs the steps of:
waiting a pre-defined “sensing time”, and
if there is activity from a primary during the “sensing time”, the recording step to record occupancy by the primary device.

11. The method of claim 10, further comprising the steps of:
implementing at least one standard protocol selected from the group consisting of MBOA ultra-wideband MAC, IEEE 802.11 protocols, TDMA protocols, and FDMA protocols; and
for each implemented standard protocol, exchanging spectrum occupancy information using an underlay approach that provides spectrum occupancy information in a transmitted information element a manner compatible with the standard.

12. The method of claim 11, when the at least one standard protocol is MBOA UWB MAC further comprising the steps of:
transmitting in an information element contained in a device-specific beacon the spectrum bandwidths that are determined to be available by the agile device; and
receiving beacons from other agile devices including the information element containing the spectrum bandwidths that are available as determined by other agile devices.

13. The method of claim 11, when the at least one standard protocol is IEEE 802.11 protocols, further comprising the steps of:
transmitting in an information element an elongated ready-to-send (RTS) message the spectrum bandwidths that are determined to be available by the agile; and
receiving in an information element of an elongated clear-to-send (CTS) message the spectrum bandwidths that are available as determined by other agile devices.

14. The method of claim 11, when the at least one standard protocol is TDMA protocols, further comprising the steps of:
dedicating as a broadcast slot one of the slots in a super frame after the transmission of a beacon frame;
collecting by a base station information for all spectrum measurements transmitted by all agile device receivers in a most recent super frame;
performing by the base station the ANDing step using the collected information; and
transmitting in the broadcast slot by the base station the results of the ANDing step to all agile device receivers.

15. The method of claim 11, when the at least one standard protocol is FDMA protocols, further comprising the steps of:
using as a control channel a predetermined channel having a lower bandwidth, in one of TDMA fashion or contention-based fashion; and
performing the transmitting and receiving steps in the control channel.

16. A carrier switching apparatus for an agile radio, comprising:
an antennas;
a receiver connected to the antenna to sense the medium for radio spectrum occupancy and receive spectrum occupancy information from other agile radios;
a transmitter connected to the antenna to use an underlay approach to transmit radio spectrum occupancy information to other agile radios; and
a carrier switching module connected to the receiver and the transmitter to respectively determine occupied parts of the radio frequency spectrum from the sensed radio spectrum occupancy, combine the data of the determined occupied parts with data of the received occupancy information to obtain the parts of the radio frequency spectrum that are not being used, and transmit the combined data as spectrum occupancy information to other agile radio,
wherein, the receiver only senses the medium when the agile radio is not transmitting and the carrier switching module switches OFF the occupied parts and switches ON the parts not being used such that whenever a new occupancy by a primary is detected, the carrier of the new occupancy is immediately switched OFF.

17. The apparatus of claim 16, further comprising
a database including at least one known primary signature and spectrum occupancy data; and
an information element processing module connected to the transmitter and database to create information elements describing occupied spectrum and transmit said elements according to a protocol of the agile radio to all agile radio receivers;
wherein said carrier switching module is further configured to create, store, retrieve and update measurements in the database of occupancy of the radio frequency spectrum as said spectrum occupancy data using said at least one known primary signature and a presence of secondaries in the sensed radio spectrum.

18. A carrier switching apparatus for an agile radio, comprising:
an antenna;
a receiver connected to the antenna to sense the medium for radio spectrum occupancy and receive spectrum occupancy information in spectrum occupancy information elements from other agile radios;
a transmitter connected to the antenna to use an underlay approach to transmit radio spectrum occupancy information in spectrum occupancy information elements to other agile radios;
an information element processing module to record sensed radio spectrum occupancy and spectrum occupancy information elements received from other agile radios and create and transmit to other agile radios spectrum occupancy information elements from recorded sensed radio spectrum occupancy information stored in the database; and
a carrier switching module connected to the receiver and the transmitter and a database wherein, said carrier switching module is configured to switch the agile radio among channels of the radio frequency spectrum.

19. The carrier switching apparatus of claim 18, wherein the carrier switching module is further configured to:
AND the transmitted and received spectrum occupancy information elements to obtain the parts of the radio spectrum that are not being used;
switch OFF transmission by the agile radio in the recorded occupied parts; and
switch ON transmission by the agile radio in the parts of the radio spectrum that are not being used.

20. A carrier switching agile radio system, comprising a plurality of agile radio devices that are configured to perform the method of claim 1 and thereby expand and contract available wireless channels opportunistically, wherein the switching of orthogonal frequency division multiplexing carriers results in increased use of the radio frequency spectrum by the agile radio system
